(19) United States
(12) Patent Application Publication
(10) Pub. No.: US 2010/0092831 A1
(43) Pub. Date: Apr. 15, 2010

(54) Fuel Cell And Fuel Cell System

(75) Inventors: Karsten Reiners, Esslingen (DE); Samuel Brandt, Esslingen (DE)

Correspondence Address: REINHART BOERNER VAN DEUREN P.C., 2215 PERRYGREEN WAY, ROCKFORD, IL, 61107, US

(73) Assignee: J. Eberspaecher GmbH & Co. KG, Esslingen (DE)

(21) Appl. No.: 12/579,961

(22) Filed: Oct. 15, 2009

(30) Foreign Application Priority Data
Oct. 15, 2008 (DE) 102008051742.9

(51) Int. Cl. H01M 8/10

(52) U.S. Cl. 429/32

(57) ABSTRACT

The present invention relates to a fuel cell for a fuel cell system, in particular in a motor vehicle, having a plurality of fuel cell elements that form a fuel cell stack, and furthermore having respectively precisely four through openings that align with one another in the fuel cell stack, forming an anode gas inlet canal, an anode gas outlet canal, a cathode gas inlet canal, and a cathode gas outlet canal. In each fuel cell element, the anode gas inlet and the anode gas outlet are diametrically opposite from one another. In each fuel cell element, the cathode gas inlet and the cathode outlet lie diametrically with respect to one another. The fuel cell stack has two end plates on which an anode gas inlet connection, an anode gas outlet connection, a cathode gas inlet connection, and a cathode gas outlet connection are configured, wherein the anode gas inlet connection is configured on the one end plate, while the cathode gas inlet connection is configured on the other end plate.

### CROSS-REFERENCE TO RELATED PATENT APPLICATIONS

This patent application claims the benefit of co-pending German Patent Application No. DE 102008051742.9, filed Oct. 15, 2008, the entire teachings and disclosure of which are incorporated herein by reference thereto.

### FIELD OF THE INVENTION

The present invention relates to a fuel cell for a fuel cell system, in particular in a motor vehicle. The invention furthermore relates to a fuel cell system equipped with such a fuel cell.

### BACKGROUND OF THE INVENTION

Fuel cells or fuel cell systems can be used on motor vehicles as an additional or sole electrical power supply. They are independent of the internal combustion engine of the respective vehicle and can thereby contribute to a savings in fuel.

Conventionally, a fuel cell comprises a plurality of disc-shaped fuel cell elements in which an electrolyte separates an anode chamber from a cathode chamber. The fuel cell elements are constructed one atop the other perpendicular to their disc plane and thereby form a fuel cell stack.

In order to achieve the most effective possible conversion of the hydrogen contained in the anode gas with the oxygen contained in the cathode gas, each fuel cell element can have a plurality of through openings that form a plurality of anode gas inlets communicating with the anode chamber, a plurality of anode gas outlets communicating with the anode chamber, a plurality of cathode gas inlets communicating with the cathode chamber, and a plurality of cathode gas outlets communicating with the cathode chamber. In the assembled fuel cell stack, the through openings of the individual fuel cell elements align and thereby form a plurality of anode gas inlet canals, a plurality of anode gas outlet canals, a plurality of cathode gas inlet canals, and a plurality of cathode gas outlet canals. Advantageously, all inlet canals are connected on a first front face of the fuel cell stack with corresponding supply lines for anode gas and cathode gas, while all outlet canals are connected on the other front face of the fuel cell stack with corresponding removal tubes or lines. In order to now be able to integrate in proper form such a fuel cell in a fuel cell system, a relatively high number of connections must accordingly be realised. Furthermore, a comparably large amount of available space is required in order to be able to lay the many connection lines.

The present invention addresses the problem of providing an improved embodiment for a fuel cell or for a fuel cell system that is characterised in particular in that it makes possible a particularly compact arrangement of the fuel cells within the fuel cell system.

### BRIEF SUMMARY OF THE INVENTION

According to the invention, this problem is solved by the subject matter of the independent claims. Advantageous embodiments are the subject matter of the dependent claims.

The invention is based on the general concept of impinging the fuel cells with the anode gas and the cathode gas in the counter current. A higher conversion rate altogether is achieved in this manner. This increased conversion rate furthermore makes it possible within the respective fuel cell elements to drastically reduce the number of required through openings. Accordingly, it is suggested to equip each fuel cell element with only precisely four through openings, namely with an anode gas inlet, an anode gas outlet, a cathode gas inlet, and a cathode gas outlet. Accordingly, the entire fuel cell stack has in the assembled state only four canals, namely an anode gas inlet canal, an anode gas outlet canal, a cathode gas inlet canal, and a cathode gas outlet canal. It is obvious that this reduced number of canals is tremendously easier to connect to corresponding lines for supplying and removing anode gas or cathode gas. At the same time, the reduced assembly difficulty is accompanied by a considerably reduced space requirement, which space can be used differently. For the counter current impingement of the fuel cells suggested here, it has been proven particularly advantageous in conjunction with the precisely four through openings per fuel cell element to arrange within each fuel cell element the anode gas inlet and the anode gas outlet in diametrically opposite corner regions of the respective fuel cell element. Accordingly, the anode gas flows through the anode chamber of the respective fuel cell element diagonally. In this manner, an increased exposure time results for the anode gas within the anode chamber, which makes an improved conversion possible.

Preferably, the fuel cell stack is provided with end plates on the front face side, which end plates make possible the different connections for connecting the four canals to corresponding tubes and lines. Corresponding to the counter current impingement, an anode gas inlet connection is formed on the one end plate, while a cathode gas inlet connection is formed on the other end plate. In order to simplify the circuitry and thus the integration of the fuel cell into the fuel cell system, it can be provided according to an advantageous embodiment to configure the cathode gas inlet connection and a cathode gas outlet connection on the same end plate. Additionally or alternatively, it can be provided to configure the cathode gas inlet connection and the anode gas outlet connection on the same end plate. Furthermore, one of the end plates can be equipped with a recirculation connection that communicates with the anode gas outlet canal. This recirculation connection can, in particular, be configured on the end plate opposite the anode gas outlet connection. The suggested arrangements for the different connections make possible a particularly compact design of the fuel cell system.

Additional important features and advantages of the invention can be found in the dependent claims, in the drawings, and in the pertinent description of the figures with reference to the drawings.

It is understood that the features described above and those to be described in what follows can be used not only in the particular cited combination, but also in other combinations or independently without departing from the scope of the present invention.

### BRIEF DESCRIPTION OF THE DRAWINGS

Preferred embodiments of the invention are shown in the drawings and are described in more detail in the following description, the same reference numerals referring to components which are the same or functionally the same or similar.

It is schematically shown in

FIG. 1 is a very simplified, partially transparent perspective view in principle of a fuel cell stack,

FIG. 2 is a very simplified, cutaway view of a fuel cell element, corresponding to cutting lines II in FIG. 3,

FIG. 3 is a very simplified top view of the fuel cell element of FIG. 2,

FIGS. 4 and 5 are respectively a very simplified, perspective view in principle of a fuel cell system in different embodiments.

While the invention will be described in connection with certain preferred embodiments, there is no intent to limit it to those embodiments. On the contrary, the intent is to cover all alternating, modifications and equivalents as included within the spirit and scope of the invention as defined by the appended claims.

### DETAILED DESCRIPTION OF THE INVENTION

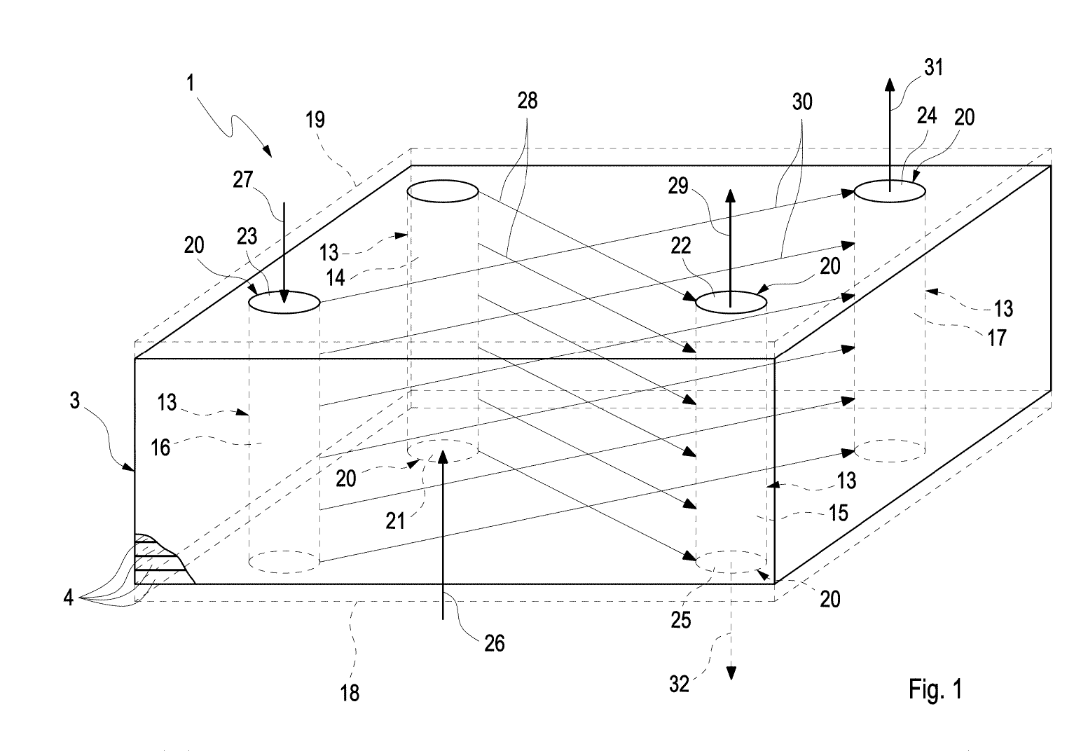

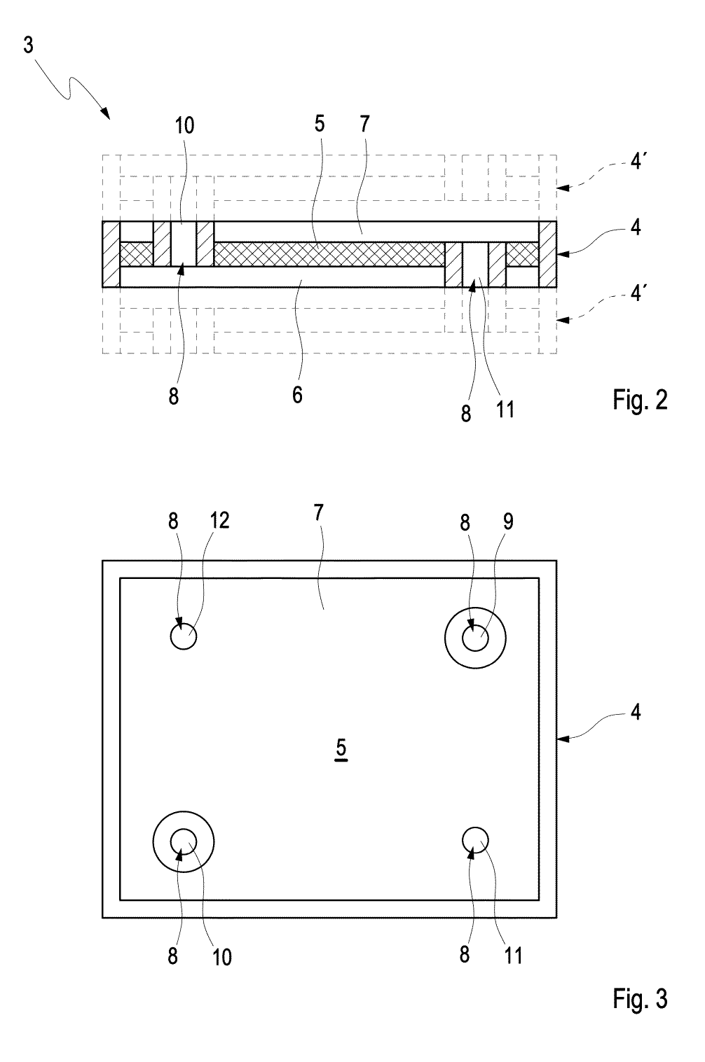

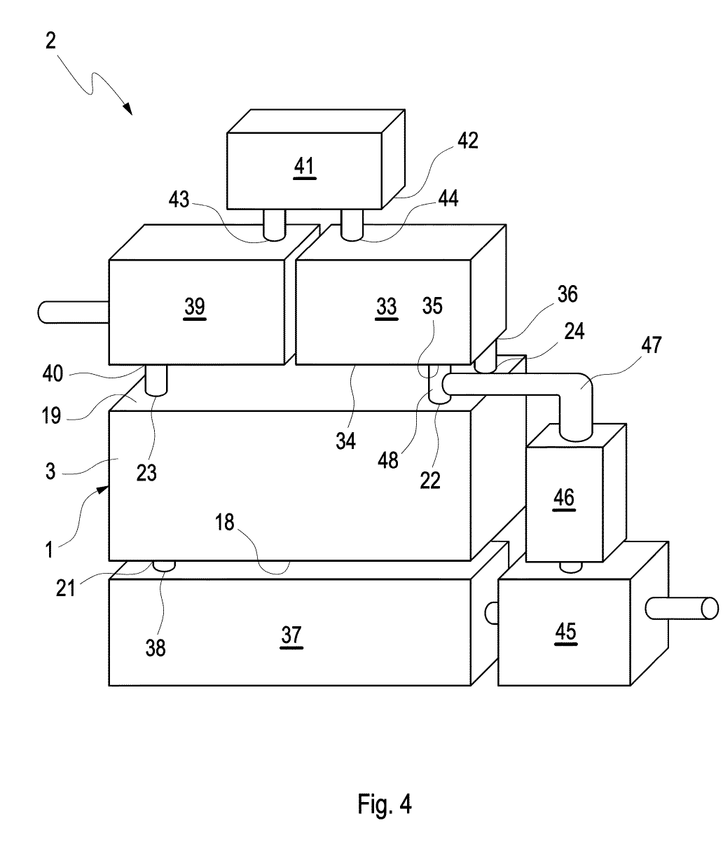

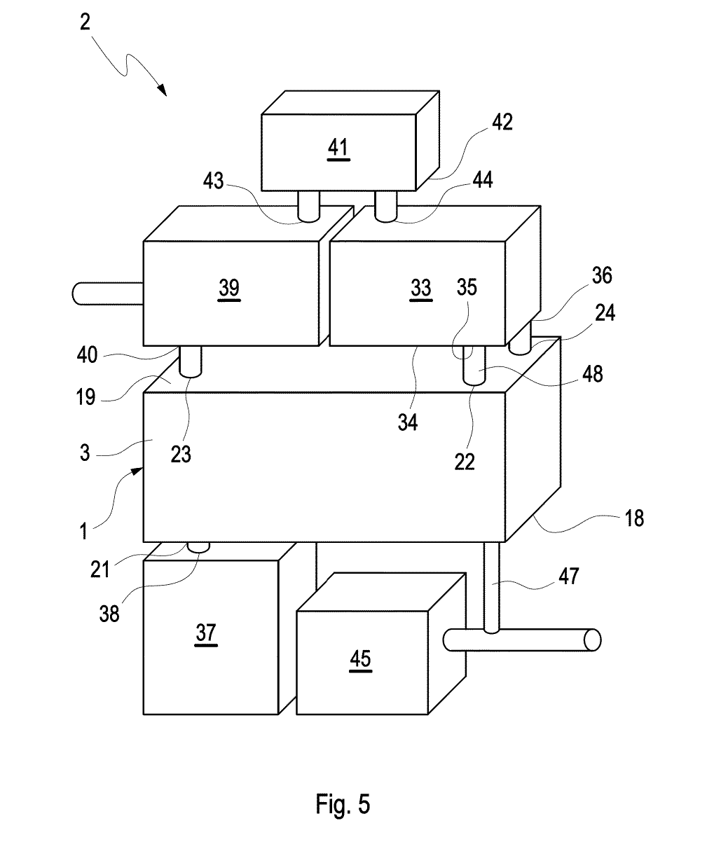

Corresponding to FIG. 1, a fuel cell 1 comprises a fuel cell system 2, of which one is shown in FIGS. 4 and 5, of a fuel cell stack 3 that is composed of a plurality of disc-shaped fuel cell elements 4. Each fuel cell element 4 has, corresponding to FIGS. 2 and 3, an electrolyte 5 that separates within the respective fuel cell element 4 an anode chamber 6 from a cathode chamber 7. In the examples shown, the respective fuel cell element 4 comprises a half anode chamber 6 and a half cathode chamber 7. Only upon assembling the fuel cell elements 4 are the anode chambers 6 and the cathode chambers 7 completed. For this purpose, the fuel cell elements 4 are constructed one atop the other perpendicular to their disc plane. Since during assembly they are essentially stacked one atop the other, they form in the assembled state the fuel cell stack 3. Installed elements are designated in FIG. 2 with reference numeral 4′. The fuel cell 1 can be configured as a PEM fuel cell 1 or as a SOFC fuel cell 1.

Corresponding to FIGS. 2 and 3, the respective fuel cell element 4 has exactly four through openings 8, namely precisely one anode gas inlet 9, precisely one anode gas outlet 10, precisely one cathode gas inlet 11, and precisely one cathode gas outlet 12. The anode gas inlet 9 and the anode gas outlet 10 respectively communicate with the anode chamber 6. In contrast thereto, the cathode chamber 7 communicates with the cathode gas inlet 11 and with the cathode gas outlet 12. The fuel cell elements 4 recognizably have a rectangular cross section that is characterized by for corner regions. The said four through openings 8 are distributed in the four corner regions, namely in such a manner that in each of the corner regions, one of the through openings 8 is arranged. Advantageously, the arrangement of the individual inlets 9, 11 and outlets 10, 12 is effected in such a manner that in each fuel cell element 4, the anode gas inlet 9 and the anode gas outlet 10 are, on the one hand, diametrically opposite one another, and furthermore in such a manner that, on the other hand, the cathode gas inlet 11 and the cathode gas outlet 12 are likewise diametrically opposite one another. Since the fuel cell elements 4 are advantageously configured to be constructed in the same way, an aligned arrangement of the individual through holes 8 of the stacked fuel cell elements 4 results within the fuel cell stack 3 corresponding to FIG. 1. Accordingly, altogether, the through openings 8 that are aligned with one another form precisely four canals 13 in the fuel cell stack 3. Individually, one anode gas inlet canal 14, one anode gas outlet canal 15, one cathode gas inlet canal 16, and one cathode gas outlet canal 17 are concerned. Corresponding to the through openings 8, the canals 13 are likewise located in the four corner regions of the rectangular fuel cell stack 3.

The fuel cell stack 3 moreover comprises two end plates, namely one first or lower end plate 18 and one second or upper end plate 19. In FIG. 1, both of the end plates 18, 19 are indicated with broken lines. They are located on opposite front faces of the fuel cell stack 3. They seal or complete the anode chamber 6 or the cathode chamber 7 of the first or of the second fuel cell element 4 and furthermore have different connections 20. Whatever the case made be, an anode gas inlet connection 21, an anode gas outlet connection 22, a cathode gas inlet connection 23, and a cathode gas outlet connection 24 are provided. In the examples shown, a recirculation connection 25 is furthermore additionally provided. The anode gas inlet connection 21 communicates with the anode gas inlet canal 14 and, in the example shown, is configured on the first end plate 18. The anode gas outlet connection 22 communicates with the anode gas outlet canal 15 and, in the example, is configured on the second end plate 19. The cathode gas inlet connection 23 communicates with the cathode gas inlet canal 16 and is configured on the second end plate 19. The cathode gas outlet connection 24 communicates with the cathode gas outlet canal 17 and here is configured on the second end plate 19. In order to realise a counter flow impingement of the fuel cell 1 with anode gas and with cathode gas, the anode gas inlet connection 21 and the cathode gas inlet connection 23 are arranged on different end plates 18, 19. In the example, the anode gas is supplied to the fuel cell 3 from below, which is indicated by a corresponding arrow 26. In contrast thereto, the cathode gas supply occurs from above according to an arrow 27 in FIG. 1. For the flow through the fuel cell stack 3 or through the individual fuel cell elements 4, the image indicated in FIG. 1 results. The anode gas enters corresponding to the arrow 26 through the anode gas inlet connection 21 into the anode gas inlet canal 14, subsequent to which it flows along anode gas paths 28, which are indicated by arrows in FIG. 1, through the anode chamber 6 of the fuel cell elements 4. At the end of the anode gas path 28, the anode gas arrives in the anode gas outlet canal 25 and can be removed through the anode gas outlet connection 22 corresponding to an arrow 29. Analogous thereto, the cathode gas enters corresponding to the arrow 27 by means of the cathode gas inlet connection 23 into the cathode gas inlet canal 16, subsequent to which it then flows along cathode gas paths 30, which are indicated in FIG. 1 by arrows, through the cathode chamber 7 of the fuel cell elements 4, thereby arriving in the cathode gas outlet canal 17 from which it can be removed through the cathode gas outlet connection 24 corresponding to an arrow 31. It has been shown that this counter flow impingement results in an increase conversion of hydrogen gas or oxygen gas in such a manner that the precisely four canals 13 provided here are sufficient.

In the example, the cathode gas outlet connection 24 and a cathode gas inlet connection 23 are configured on the same end plate 19, while the anode gas inlet connection 21 and the anode gas outlet connection 22 are configured on different end plates 18, 19. In the examples shown in FIG. 1, it is furthermore provided to configure the recirculation connection 25 and the anode gas outlet connection 22 on different end plates 18, 19. Anode gas can also be removed from the fuel cell stack 3 through the recirculation connection 25 corresponding to an arrow 32 indicated by a broken line. The anode gas that is removed through the anode gas outlet connection 22 and through the recirculation connection 32 is an anode off-gas, that is to say anode gas with a reduced hydrogen content. The cathode gas leaving from the cathode gas outlet connection 24 is, correspondingly, a cathode off-gas that exhibits a reduced oxygen content. In the example, the upper or second end plate 19 is configured in such a manner that it seals the anode gas inlet canal 14 on its upper front face of the fuel cell stack 3. In contrast thereto, the first or lower end plate 18 is configured in the example in such a manner that it axially seals the cathode gas inlet canal 16 and the cathode gas outlet canal 17 on the lower front face of the fuel cell stack 3. The through openings 8 and thus the canals 13 have circular cross sections in the example. It is evident that, in principle, any cross sections are realisable. The canals 13 extend parallel to the stack direction of the fuel cell elements 4, that is to say perpendicular to the disc planes of the fuel cell elements 4.

Corresponding to FIGS. 4 and 5, the fuel cell system 2, in addition to the fuel cell 1, comprises a residual gas burner 33 that has an inlet wall structure 34. This inlet wall structure 34 has an anode off-gas inlet 35 and a cathode off-gas inlet 36. The anode off-gas inlet 35 is communicatingly connected to the anode gas outlet connection 22 of the fuel cell block 3. In contrast thereto, the cathode off-gas inlet 36 is communicatingly connected to the cathode gas outlet connection 24 of the fuel cell block 3. In the example, the residual gas burner 33 is arranged with its inlet wall structure 34 in close proximity to the upper end plate 19 of the fuel cell stack 3. In a different embodiment, this inlet wall structure 34 can at least partially form the upper end plate 19. In particular, an embodiment is conceivable in which the entire upper end plate 19 is formed by the inlet wall structure 34 of the residual gas burner 33.

In the example, a reformer 37 is furthermore provided by means of which the anode gas can be produced. The reformer 37 has a combustion gas outlet 38 that is communicatingly connected to the anode gas inlet connection 21 of the fuel cell stack 3. The reformer 37 generates a synthetic combustion gas, or syngas, that can be used as anode gas. It contains hydrogen gas. Advantageously, the reformer 37 can catalytically reform. In principle, a steam reformation is also conceivable.

In the examples shown, a heat exchanger 39 is moreover provided that connects the burner exhaust gas coming from the residual gas burner 33 with cathode gas in a heat-transferring manner, said mixture being intended to be supplied to the fuel cell 1. In the advantageous embodiment shown here, the heat exchanger 39 and the residual gas burner 33 are arranged on the same end plate, that is to say on the upper end plate 19 here. A cathode gas outlet 40 of the heat exchanger 39 is communicatingly connected to the cathode gas inlet connection 23 of the fuel cell stack 3.

The cathode gas is preferably air. The supply of air to the heat exchanger 39 is realised by means of a conveyor device 41, for example a blower that at the same time also supplies the residual gas burner 33 with air. This air supply of the residual gas burner 33 can be used for cooling. Accordingly, an outlet side 42 of the conveyor device 41 is, on the one hand, connected to a cathode gas inlet 43 of the heat exchanger 39 and, on the other hand, is connected to a cooling gas inlet 44 of the residual gas burner 33.

Moreover, the fuel cell systems 2 shown here are respectively equipped with an additional conveyor device 45 that can likewise be a blower or a compressor or a pump. By means of this conveyor device 45, recirculated anode gas or recirculated anode off-gas is supplied to the reformer 37. Depending on the resistance to heat of the conveyor device 45, a recirculation heat exchanger 46 can additionally be provided, corresponding to FIG. 4, by means of which recirculation heat exchanger the recirculated anode gas can be cooled prior to being supplied to the conveyor device 35. For example, the recirculation heat exchanger 46 can be connected to an air supply that supplies the reformer 37 with air or with oxidant gas. In the embodiment shown in FIG. 4, a recirculation line 47 is connected to an anode off-gas line 48 in the region of the anode gas outlet connection 22, said recirculation line connecting the anode gas outlet connection 22 to the anode off-gas inlet 35 of the residual gas burner 33. In this case, the recirculation connection 25 shown in FIG. 1 is dispensed with. In contrast thereto, FIG. 5 shows an embodiment in which the recirculation connection 25 shown in FIG. 1 is used in order to connect the recirculation line 47 in order to be able to remove anode off-gas for purposes of recirculation to a side of the fuel cell 1 that faces away from the anode gas outlet connection 22. A particularly compact arrangement can, for example, be hereby realised.

The fuel cell systems 2 shown here, which are configured particularly compactly, characterise themselves in particular by the fact that the residual gas burner 33 and the heat exchanger 39 are positioned within the fuel cell 1 with regard to a projection that is oriented perpendicularly to the stack direction of the fuel cell elements 4. In the same direction of projection, the reformer 37 is also housed within the fuel cell 1; however, on a side facing away from the residual gas burner 33. In this manner, a particularly compact outline for the fuel cell system 2 results. In the embodiment shown in FIG. 5, the conveyor device 45 is additionally arranged within the fuel cell 1 in reference to the said direction of projection.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fuel cell for a fuel cell system,
having a plurality of disc-shaped fuel cell elements in which an electrolyte separates an anode chamber from a cathode chamber, said fuel cell elements furthermore being installed one on top of the other perpendicularly to their disc plane and forming a fuel cell stack,
wherein the fuel cell elements respectively have precisely four through openings that in the assembled state form an anode gas inlet communicating with the anode chamber, an anode gas outlet communicating with the anode chamber, a cathode gas inlet communicating with the cathode chamber, and a cathode gas outlet communicating with the cathode chamber,
wherein in the fuel cell stack the through openings of the individual fuel cell elements align with one another and form an anode gas inlet canal, an anode gas outlet canal, a cathode gas inlet canal and a cathode gas outlet canal,
wherein the anode gas inlet and the anode gas outlet are diametrically opposite from one another in each fuel cell element,
wherein the cathode gas inlet and the cathode outlet are diametrically opposite from one another in each fuel cell element,
wherein the fuel cell stack has two end plates on which are configured an anode gas inlet connection communicating with the anode gas inlet canal, an anode gas outlet connection communicating with the anode gas outlet canal, a cathode gas inlet connection communicating with the cathode gas inlet canal, and a cathode gas outlet connection communicating with the cathode gas outlet canal,
wherein the anode gas inlet connection is configured on the one end plate, while the cathode gas inlet connection is configured on the other end plate.

2. The fuel cell according to claim 1, wherein the cathode gas outlet connection and the cathode gas inlet connection are configured on the same end plate.

3. The fuel cell according to claim 1, wherein the anode gas outlet connection and the cathode gas inlet connection are configured on the same end plate.

4. The fuel cell according to claim 1, wherein a recirculation connection is furthermore configured on one of the end plates, which recirculation connection communicates with the anode gas outlet canal.

5. The fuel cell according to claim 1, wherein the recirculation connection and the anode gas outlet connection are configured on different end plates.

6. The fuel cell according to claim 1, wherein
the fuel cell elements respectively have a rectangular cross section that has four corner regions,
the four through openings are distributed at the four corner regions so that a through opening is arranged in each corner region.

7. A fuel cell system
having a fuel cell with a plurality of disc-shaped fuel cell elements in which an electrolyte separates an anode chamber from a cathode chamber, said fuel cell elements furthermore being installed one on top of the other perpendicularly to their disc plane and forming a fuel cell stack,
having a residual gas burner that has an inlet wall structure,
wherein the fuel cell elements respectively have precisely four through openings that in the assembled state form an anode gas inlet communicating with the anode chamber, an anode gas outlet communicating with the anode chamber, a cathode gas inlet communicating with the cathode chamber, and a cathode gas outlet communicating with the cathode chamber,
wherein in the fuel cell stack the through openings of the individual fuel cell elements align with one another and form an anode gas inlet canal, an anode gas outlet canal, a cathode gas inlet canal and a cathode gas outlet canal,
wherein the anode gas inlet and the anode gas outlet are diametrically opposite from one another in each fuel cell element,
wherein the cathode gas inlet and the cathode outlet are diametrically opposite from one another in each fuel cell element,
wherein the fuel cell stack has two end plates on which are configured an anode gas inlet connection communicating with the anode gas inlet canal, an anode gas outlet connection communicating with the anode gas outlet canal, a cathode gas inlet connection communicating with the cathode gas inlet canal, and a cathode gas outlet connection communicating with the cathode gas outlet canal,
wherein the anode gas inlet connection is configured on the one end plate, while the cathode gas inlet connection is configured on the other end plate.
wherein the inlet wall structure has an anode off-gas inlet communicating with the anode gas outlet connection, and furthermore has a cathode off-gas inlet communicating with the cathode gas outlet connection,
wherein the residual gas burner is arranged with its inlet wall structure on one of the end plates or at least in part forms one of the end plates.

8. The fuel cell system according to claim 7, wherein the anode gas outlet connection and the cathode gas outlet connection are configured on the same end plate, and namely on the end plate on which the residual gas burner is arranged or that is at least in part formed by the residual gas burner.

9. The fuel cell system according to claim 7, wherein a reformer is provided the combustion gas outlet of which communicates with the anode gas inlet connection and that is arranged on the other end plate with regard to the residual gas burner.

10. The fuel cell system according to claim 7, wherein the fuel cell system is arranged in a motor vehicle.

11. The fuel cell system according to claim 7, wherein a heat exchanger is provided that is arranged on the same end plate as the residual gas burner and that furthermore combines the burner exhaust gas coming from the residual gas burner with the cathode gas to be supplied to the fuel cell in a heat-transferring manner, and moreover the cathode gas outlet of said heat exchanger communicates with the cathode gas inlet connection of the fuel cell.

12. The fuel cell system according to claim 7, wherein the cathode gas outlet connection and the cathode gas inlet connection are configured on the same end plate.

13. The fuel cell system according to claim 7, wherein the anode gas outlet connection and the cathode gas inlet connection are configured on the same end plate.

14. The fuel cell system according to claim 7, wherein a recirculation connection is furthermore configured on one of the end plates, which recirculation connection communicates with the anode gas outlet canal.

15. The fuel cell system according to claim 7, wherein the recirculation connection and the anode gas outlet connection are configured on different end plates.

16. The fuel cell system according to claim 7, wherein
the fuel cell elements respectively have a rectangular cross section that has four corner regions,
the four through openings are distributed at the four corner regions so that a through opening is arranged in each corner region.
